(19) United States
(12) Patent Application Publication
(10) Pub. No.: US 2015/0161738 A1
(43) Pub. Date: Jun. 11, 2015

(54) Method of determining a risk score or insurance cost using risk-related decision-making processes and decision outcomes

(71) Applicant: Jeffrey Stempora, Erie, PA (US)

(72) Inventor: Jeffrey Stempora, Erie, PA (US)

(73) Assignee: Advanced Insurance Products & Services, Inc., Erie, PA (US)

(21) Appl. No.: 14/182,002

(22) Filed: Feb. 17, 2014

Related U.S. Application Data
(60) Provisional application No. 61/914,125, filed on Dec. 10, 2013.

(51) Int. Cl. G06Q 40/08

(52) U.S. Cl. CPC G06Q 40/08

(57) ABSTRACT

In one embodiment, a method of generating a risk score, a cost of insurance, or a risk score and a cost of insurance for at least one individual comprises directly monitoring or inferring the risk-related decision-making processes and directly monitoring the resulting decision outcomes for decisions. The method may further comprise correlating risk-related decision-making processes and the decisions with the resulting decision outcomes. In another embodiment, the method further comprises building cognitive maps for one or more individuals, acquiring contextual data related to the decisions, or prospectively determining a probability of outcome for a risk-related situation using the one or more cognitive maps. In one embodiment, the insurance is automobile insurance and data is obtained through telematics and/or a portable device.

### TECHNICAL FIELD

The subject matter disclosed herein generally relates to determining the level of risk associated with at least one individual and generating a risk score, a cost of insurance, or a cost of insurance and a risk score for at least one individual.

### BACKGROUND

New methods are needed that can more accurately assess and price risk. A method is needed that can better predict losses based on risk-related judgments and their respective outcomes to appropriately assess risk and assign equitable pricing. These risk assessments could be used to provide risk scores, a cost of insurance, or both.

### SUMMARY

In one embodiment a method of generating a risk score, a cost of insurance, or a risk score and a cost of insurance for at least one individual comprises directly monitoring or statistically inferring risk-related decision-making processes and directly monitoring resulting decision outcomes for decisions made by the at least one individual; and basing the risk score, the cost of insurance, or the risk score and the cost of insurance for the at least one individual at least in part on one or more correlations between the risk-related decision-making processes and the decisions with the resulting decision outcomes. In one embodiment, a cognitive map comprising the risk-related decision-making processes and the decisions made in different risk-related situations is generated for one or more individuals. In another embodiment, the method further comprises building cognitive maps for one or more individuals, acquiring contextual and risk or loss exposure data related to the decisions, or prospectively determining a probability of outcome for a risk-related situation using the one or more cognitive maps. In one embodiment, the insurance is automobile insurance and data is obtained through telematics, and/or a portable device, and/or a wearable device.

### BRIEF DESCRIPTION OF THE DRAWINGS

FIG. 1 is an information flow diagram view of one embodiment of a method of determining a risk assessment, risk score, underwriting, or cost of insurance for an individual.

FIG. 2 is an information flow diagram view of one embodiment of a method of determining a risk assessment, risk score, underwriting, or cost of insurance for an individual and providing feedback or behavior modification information, methods, or activities for the individual.

### DETAILED DESCRIPTION

The features and other details of the invention will now be more particularly described. It will be understood that particular embodiments described herein are shown by way of illustration and not as limitations of the invention. The principal features of this invention can be employed in various embodiments without departing from the scope of the invention. All parts and percentages are by weight unless otherwise specified.

### Risk Assessment, Risk Scores, Underwriting, and Cost of Insurance

In one embodiment, a risk assessment, a risk score, an underwriting, or a cost of insurance is determined by examining information related to decisions made by one or more individuals. The decision information may include decision-making processes used, decisions made, outcomes of the decisions, circumstances under which the decisions are made, and other information. Correlations between the risk-related decision-making processes and the decisions with the resulting decision outcomes can be used to provide information for a risk assessment, risk score, underwriting or the cost of insurance. A predictive model can be used to assess the proper risk premium to charge for underwriting activities is critical for fair and equitable distribution of the cost of risk. Information related to an individual's propensity to take risks relative to a given context or set of conditions can be used to determine the risk assessment, risk score, underwriting or the cost of insurance. In one embodiment, a cognitive map is generated that includes the correlations between risk-related decision-making processes and the decisions made by the at least one individual in different risk-related situations. In one embodiment, a cognitive map may be for an individual, a group of individuals, or both individuals and groups of individuals.

One or more decision-making processes for an individual may include a heuristic. The heuristics that exist within an individual can inherently bias that individual toward risk taking behavior. By identifying these heuristics, not only can an underwriting entity determine the proper relative risk score, and therefore the proper premium to charge, but also has the opportunity to provide feedback on the use of these heuristics and how they can lead to errors in judgment. In such a manner, individuals can be conditioned to adopt new and better heuristics and establish lower risk profiles in areas such as auto insurance, life insurance, homeowners insurance, medical insurance, financial loans, investments, etc.

### Frequency of Adjustment

In one embodiment, an initial underwriting profile for an individual comprises an initial risk assessment, an initial risk score, an initial underwriting, or an initial cost of insurance. In another embodiment, the initial underwriting profile is subsequently adjusted based upon one or more decisions, decision-making processes, and/or decision outcomes for the individual. In one embodiment, the risk assessment, risk score, underwriting or the cost of insurance is adjusted in one or more time intervals selected from the group: real-time, within a minute, within an hour, within a day, within a week, within a month, within a quarter, twice a year, yearly, every two years, and within a multi-year timespan. In one embodiment, the adjustment is made or triggered after identification of data from one or more specific events, a change in environmental or individual conditions, a change in actual or perceived risk or loss exposure information, individual decisions, individual decision outcomes, input from external sources, or specific contextual information. In another embodiment, the adjustment is made at one or more specific times determined by the individual, underwriter, or third-party.

### Initial Underwriting Profile Generation

In one embodiment, the initial underwriting profile is generated through traditional means, such as credit scoring, that serves as an underwriting baseline or constant upon which discounts are applied based on a different underwriting method. In one embodiment, the initial underwriting profile comprises information received from the individual or other data sources and/or the results of processing the information received from the individual or other data sources. In one embodiment, the information received from the individual is obtained through a survey, test, or initial monitoring. In one embodiment, a survey, test, or initial monitoring infers or monitors one or more decision-making processes and decision outcomes for one or more decisions in one or more contextual situations. In another embodiment, one or more initial correlations are made between the risk-related decision-making processes and the decisions with the resulting decision outcomes. In one embodiment, an initial underwriting profile is generated subsequent to monitoring and analyzing information from the individual related to one or more decisions made in one or more risk-related situations. In another embodiment, the individual is rated on a scale ranging from a very risk-seeking individual to a very risk-averse individual. In another embodiment, the individual is initially segmented according to one or more risk scores, risk scales, or risk-related categories.

### Risk-Related Situations and Decisions

In one embodiment information related to risk-related decisions made by an individual in one or more risk-related situations is analyzed to provide information for the risk assessment, the risk score, the underwriting, or the cost of insurance. Risk-related situations are situations wherein an individual may make a decision or choice among multiple courses of action (including inaction) that involve various levels of risk whether real, imagined, or contrived. The risk level may range from a very low level of risk to a very high level of risk.

### Risk-Related Decisions and Decision-Making Processes

Decision-making processes are the processes by which an individual or group of individuals makes a selection between possible courses of action (including inaction). Generally, the processes may be classified as analytical in nature (referred to as System 2) or autonomic/habitual in nature (referred to as System 1). Heuristics are examples of decision-making processes that often are autonomic in nature. The decision may be a risk-related judgment or evaluation and the risk-related decision information may be used for the judgment.

### Risk-Related Decision Information

Risk-related decision information can include one or more of the following: the cognitive map for the individual; information on one or more decision-making processes used to make one or more decisions (including reflexive or heuristic decision-making processes, analytical or reflective decision-making processes, the preference, dominance, or relative proportion of use of reflexive or heuristic decision-making processes relative to analytical or reflective decision-making processes); the decision outcome (including negative, positive, or neutral properties); contextual information for the decision; risk and loss exposure information; one or more negative or positive correlations between one or more decision-making processes and one or more decision outcomes; and one or more positive predictive factors or negative predictive factors for predicting one or more positive decision outcomes or negative decision outcomes, respectively.

In one embodiment, the risk-related decision information obtained from data sources is used to determine one or more of the following: when one or more risk-related decisions were made; which decision-making heuristic processes were used in the one or more risk-related decisions; the classification of the individual into one or more groups (based on common or similar risk-related decision information, contextual information, traits, physical or mental condition, personalities, level of the risk behavior from risk-seeking to risk-averse, social connections with other individuals, or other demographic information); contextual information for the decision; risk and loss exposure information; the characterization of the use of a specific decision-making process in a specific situation (either generally, by a specific individual, or a group of individuals) as risk-seeking, risk-averse or a level of risk between risk-seeking and risk-averse; the identification of a decision outcome; if the outcome is positive, neutral, or negative; the preference, dominance, or relative proportion of System 1 decision-making processes to System 2 decision-making processes; and the correlation between one or more decision-making processes with one or more decision outcomes.

### Reflexive or Heuristic Decision-Making Processes

In one embodiment, a method of generating a risk score, a cost of insurance, or a risk score and a cost of insurance for at least one individual is based at least in part on the use by an individual of one or more risk-related heuristic decision-making processes. As used herein, a heuristic is a decision-making method or method of making a choice whereby the decision or choice is based on a subset of the information or only certain aspects of the situation under consideration. Heuristics simplify the decision process relative to a full analytical decision-making process. Heuristics can be thought of as short cuts, rules-of-thumb, or simplified judgments and they generally require less cognitive resources than a fully analytical process, but can often lead to errors. Heuristics are consistent with the bounded rationality model of decision-making where the ability of individuals to be rational in a decision is limited by cognitive capacity, the amount of contextual information related to the decision, and time available to make the decision. Examples of heuristics include reflexive decision-making processes, which refer to the process of making decisions or choices purely based on gut instinct. In reflexive decision-making processes the decision-maker makes a choice based on intuition or how it feels to him or her. As used herein, reflexive or automatic decision-making processes are referred to as System 1 decision-making process. Other examples of heuristics include, but are not limited to: anchoring, representativeness, base rate fallacy, conjunction fallacy, dilution effect, misperception of randomness, ignorance of sample size, affect, control, effort, scarcity, attribute substitution, consensus, confirmation bias, and overconfidence. Other heuristics or cognitive impairments, such as those related to PTSD and those known and unknown in the science of cognitive psychology, may be used in a method of generating a risk score, a cost of insurance, or a risk score and a cost of insurance.

### Analytical or Reflective Decision-Making Processes

In one embodiment, a method of generating a risk score, a cost of insurance, or a risk score and a cost of insurance for at least one individual is based at least in part on the use by an individual of one or more risk-related analytical or reflective decision-making processes. As used herein, an analytical, reflective, or high level of concentration decision-making process is referred to as a System 2 decision-making process and is a rational-economic process of judgment or decision-making whereby an individual considers all available information relating to the decision process, analyzes it, and comes to a rational conclusion or choice based on the process. Analytical decision-making takes more time and requires more cognitive capacity and concentration than heuristics or reflexive decision-making.

### Primary Task Decisions

In one embodiment, information related to one or more primary decisions is used to determine the risk assessment, the risk score, the underwriting, or the cost of insurance. Primary task decisions include decisions whose resulting decision outcomes are directly associated with risk for the assessment, underwriting, or insurance. For example, an individual's actions operating an automobile are decision outcomes of primary task decisions associated with the risk for automobile insurance.

### Secondary or Tertiary Task Decisions

In one embodiment, information related to one or more secondary and/or tertiary decisions is used to provide information for determining the risk assessment, the risk score, the underwriting, or the cost of insurance. Secondary task decisions include decisions secondary to the primary task decisions and the resulting decision outcomes of the secondary task decisions are indirectly associated with risk for the assessment, underwriting, or insurance. For example, an individual's actions operating a cellphone (secondary task) are decision outcomes of secondary task decisions if the individual is simultaneously operating an automobile (primary task). Similarly, tertiary task decision information may be used to provide the risk assessment, the risk score, the underwriting, or the cost of insurance. Tertiary task decisions, for example, include choosing to listen to the radio (tertiary task decision) while choosing to operating a vehicle (primary task decision) and choosing to talk on a cellphone (secondary task decision), wherein information related to each of these decisions may provide information associated with the risk for automobile insurance. In this example, the decision processes used to decide why to answer a phone call while driving a vehicle, the decision processes used to decide not to turn down the radio, and other information related to these decisions, such as contextual information (such as the caller identified as the mother of the individual) can be used to help determine the cost of automobile insurance. Similarly, decision information with positive outcomes, such as in the context of the previous example, turning down the radio before answering the phone and/or stopping the vehicle before answering the phone can be used to help determine the cost of automobile insurance.

### Contextual Information

In one embodiment, the risk assessment, the risk score, the underwriting, or the cost of insurance is determined using contextual information related to the decisions made by at least one individual. Contextual information, as used herein, refers to data regarding the surroundings, environment, circumstances, background, reasoning, or settings that determine, specify, interpret, or clarify the meaning of an event or other occurrence. In one embodiment, the contextual information directly or indirectly provides information related to the decision-making process. In one embodiment, the contextual information provides supporting information that increases the probability of occurrence, or confirms an occurrence or the conditions of a specific decision or decision-making process. Contextual information can include the conditions surrounding an event such as a decision and can include the physical or mental state of the individual. In another embodiment, historical contextual information may be used to provide decision related information or information that can be used to deduce other decision related information.

For example, in the context of automobile insurance, contextual information may be used to determine that a vehicle operator is late for work. In this example, context information could include historical data of normally leaving the home 10 minutes prior, a text message including the phrase “I'm late for work,” or an irregularity in a normal routine (such as turning on the vehicle 10 minutes later than normal). In this example, the fact that the vehicle operator is running late (such as direct admission in a text message or inferred from the deviation from a normal time leaving their home) is contextual information relating to the decision of whether or not to speed to work or run a yellow light (risk-seeking behavior) or calling work to move a meeting (risk-averse). In another example, a vehicle operator who is normally sleeping and inactive between 11 pm and 5:30 am that is driving a vehicle at lam (as determined through GPS, mobile device, road infrastructure, or telematics information in conjunction with vehicle driver identification) may be considered risk-seeking in the decision to drive at that hour. As is clear from these examples, contextual information from a plurality of sources may be used to confirm or increase the accuracy of the decision related information. In one embodiment, a pattern of behavior is identified through contextual information, wherein the deviation from the pattern is identified and used to confirm or increase the accuracy of the decision information.

### Risk or Loss Exposure Information

In one embodiment, the risk assessment, the risk score, the underwriting, or the cost of insurance is determined using risk or loss exposure information related to the decisions made by at least one individual. As used herein, the risk exposure information related to a decision or judgment made by an individual is the information related to the exposure of the individual to one or more risks that could affect the decision-making process or the judgment process. As used herein, the loss exposure information related to a risk-related decision or judgment made by an individual comprises information related to the asset (such as a vehicle, for example), information related to the peril or covered risk (as opposed to non-covered risk), and information related to the consequences of the loss (such as getting a scratch on a vehicle that leads to a reduced valuation, for example).

The risk exposure information can include information related to the actual or perceived overall effect (such as a loss or a negative outcome) of identified risks and the actual or perceived probability of the risk occurring. The risk exposure information can include information related to the actual or perceived impact (financial impact, intangible impact, time impact, etc.) if the risk were to occur. For example, if a driver has a separate umbrella insurance policy covering automobile collisions in addition to standard automobile insurance policy covering collisions, the actual (and/or perceived) financial risk (or impact) in the event of a collision could be reduced. In this example, information related to the standard automobile insurance coverage and the umbrella insurance policy is risk exposure information that can affect the decisions or judgments made by the individual. Similarly, the financial wealth (or lack thereof) of an individual can affect the actual or perceived financial impact if the risk were to occur. Other risk exposure information can include actual or perceived information selected from the group: the amount of the loss covered by an insurance policy; the health of the individual; the ability to recover from the loss or event; and the financial, mental, or physical condition of the individual or property.

The risk exposure information can affect the use of one or more decision-making heuristics in a risk-related decision or judgment. In one embodiment, a correlation between risk exposure information and the use of one or more heuristics is used to determine the risk assessment, the risk score, the underwriting, or the cost of insurance for an individual

### Decision Outcomes

A decision outcome includes the results of a decision process and a decision made. In one embodiment, information related to one or more decision outcomes is acquired and/or monitored and used to help in determining the risk assessment, the risk score, the underwriting, or the cost of insurance. In one embodiment, the data related to a decision outcome is used to determine the decision made by an individual and/or to help identify one or more decision processes used by the individual to make the decision. For example, monitoring the telematics data from a vehicle may help identify a decision by the driver to change lanes, a decision to drive in the snow, or a decision to drive below the speed limit in raining conditions. One or more decision outcomes may be classified as positive, negative, or neutral. Neutral decision outcomes are those deemed to not have an inherent favorable or unfavorable nature, to not be relevant to the risk, or have little relevancy to the risk associated with a primary task. In one embodiment, decision outcomes that are neutral for one type of insurance may be negative or positive for a different type of insurance or risk, for example. In one embodiment, the decision outcome is a judgment or evaluation made using one or more decision-making processes (such as heuristics or analytical processes).

### Negative Decision Outcomes

In one embodiment, information related to negative decision outcomes is used to help determine the risk assessment, the risk score, the underwriting, or the cost of insurance. Negative decision outcomes include outcomes from a decision which are unfavorable or undesirable in nature especially as they pertain to risk. For example, data relating to a car crash can be negative decision outcome information (such as in the case of a driver's decision to pass a car around a curve in the road identified using telematics and geographical information) in the context of automobile insurance rates.

### Positive Decision Outcomes

In one embodiment, information related to positive decision outcomes is used to help determine the risk assessment, the risk score, the underwriting, or the cost of insurance. Positive decision outcomes include outcomes from a decision which are favorable or desirable in nature especially as they pertain to risk. For example, data relating to a successful trip completion (such as vehicle location determined to be at target destination) and vehicle speed information (such as acquired by the vehicle's On-board-Diagnotistics-2 (OBD2) device) by a vehicle operator can be information related to a positive decision (such as a decision not to drive over the speed limit) in the context of automobile insurance rates.

### First Decisions Affecting Second Decisions

In one embodiment, a risk assessment, a risk score, an underwriting, or a cost of insurance is determined at least in part on a relationship or a correlation between a first decision or first decision outcome and a second decision or second decision outcome. In another embodiment, a first decision or decision outcome affects (directly or indirectly) a second decision or decision outcome. For example, in the context of determining the cost of automobile insurance, the first decision of a driver running late for work to speed can affect a second decision to pass through a red light. A first risk-related decision may be associated with a low or high level of risk and a second risk-related decision related or correlated with the first risk-related decision may have low or high level of risk. In one embodiment, a first decision with a low level of risk has a high correlation with a second decision with a high level of risk. In one embodiment, the first risk-related decision, the first risk-related decision outcome, the first and second risk-related decisions, and/or the correlation between the first and second risk-related decisions may be used to determine a risk assessment, a risk score, an underwriting, or a cost of insurance.

In another embodiment, a risk assessment, a risk score, an underwriting, or a cost of insurance is determined at least in part on a first risk-related judgment decision of an individual that affects a second risk-related decision. In one embodiment, a first decision or first decision outcome is contextual information for a subsequent second decision. For example, in the context of determining the cost of automobile insurance, a driver who frequently judges a distance to be much further or closer than the actual distance may use the incorrect judgments to make other risk-related decisions. In this example, a driver's judgment of a distance required to stop, a distance from another vehicle in front of the driver, or a distance till the next highway off-ramp can affect a subsequent risk-related decision such as when to stop the vehicle, or when to change lanes.

### Monitoring or Inferring the Decision-Making Process

In one embodiment, information related to the decision-making process is directly monitored or inferred. Inferring the risk-related decision-making processes includes using decision outcomes from known or inferred related decisions to statistically deduce or infer the decision-making process that led to the decision and its outcomes. In another embodiment, contextual information related to the decision is acquired and used to help identify one or more decision-making processes or the statistical probability of using one or more decision-making processes. In a further embodiment, risk exposure information related to the decision is acquired and used to help identify the use of one or more decision-making processes or the statistical probability of using one or more decision-making processes.

Information related to the decision-making process may be obtained from one or more data sources and may be processed by a decision-making processes algorithm to help identify one or more decision-making processes or statistical correlations with other decision information for the same individual in similar risk-related situations, the same individual in different risk-related situations, other individuals in similar risk-related situations as the individual, or other individuals in different risk-related situations. In another embodiment, the decision information is compiled in a cognitive map for the individual. In one embodiment, heuristic decision-making techniques for the individual are monitored directly or indirectly through analyzing the decision information (which can include contextual information, cognitive information, or risk and loss exposure information). In this embodiment, monitoring one or more of the heuristic decision-making techniques used by the individual can be used to determine a propensity to take risks which could be used to provide information to help determine the risk assessment, the risk score, the underwriting, or the cost of insurance. In one embodiment, a probability of using one or more decision-making processes by the individual for one or more decisions is calculated using decision information for the individual and optionally using decision information from other individuals in similar or different risk-related situations.

For example, decision information that can help identify or increase the probability of identifying the decision-making process used by the individual for one or more decisions can include: sampling data from numerous similar events, using contextual information to determine correlations of instances of speeding or driving through a yellow or red light with being late for work (as determined via contextual information) on multiple occasions (in the context of automobile insurance); or instances of distracted driving determined through contextual information from a cellphone and telematics information from the vehicle operated by the individual.

In one embodiment, one or more decision-making processes for the individual is identified or the probability of using one or more decision-making processes is determined using one or more processes selected from the group: correlating decision information for the risk-related situation with decision information for previous situations for the individual where the decision process used is known (or known with a high probability); correlating decision information for the risk-related situation with decision information from other individuals previously in similar or different risk-related situations where the decision process used is known (or known with a high probability); correlating decision information from one or more decisions from one or more individuals; and comparing the cognitive map from the individual with one or more cognitive maps from one or more other individuals.

In another embodiment, one or more decision-making processes for the individual is identified or the probability of using one or more decision-making processes is determined using information from one or more data sources selected from: the initial underwriting profile, external data sources, third-party data sources, a wearable device (smart watch, pulse monitor, contact lens, etc.), a portable device (cellphone, etc.), a telematics device, a medical device (magnetoencephalography (MEG) device, etc.), a computing device (tablet computer, laptop computer, desktop computer, etc.), and other electronic device.

In another embodiment, decision information for one or more risk-related situations is used to help identify conditions where the individual uses (or has a statistical likelihood of using) a reflexive or heuristic decision-making technique, or an analytical or reflective decision-making process technique. In one embodiment, a method of determining the risk assessment, the risk score, the underwriting, or the cost of insurance for an individual includes identifying conditions where the individual uses (or has a statistical likelihood of using) a reflexive or heuristic decision-making process, identifying or inferring the reflexive or heuristic decision-making process used; and correlating the reflexive or heuristic decision-making process and the decisions with the resulting decision outcomes.

### Data Capture and Sources

In one embodiment, decision information or information used to generate decision information is obtained from one or more data sources selected from the group: data supplied by the individual; a portable or wearable device; a telematics device or vehicle or craft comprising a telematics device, data recorder or one or more sensors; a building or structure system (such as an alarm system or automation system for a home or building); a medical device; a magnetoencephalography device; government data sources; industrial control systems; one or more sensors or one or more devices comprising one or more sensors; and external data providers, external data sources, or external networks. The decision information may be received directly or indirectly from the data source and information from the data source may be processed (such as by a processor executing a decision-making process algorithm) to generate other decision information. The decision information, information used to generate decision information, situation information, propensity model algorithm, predictive model algorithm, cognitive maps of individuals, risk score, cost of insurance information, algorithms used to generate the risk score or cost of insurance, or feedback or behavior modification algorithms may be stored on one or more non-transitory computer-readable media that are connected or in communication with one or more devices (including portable devices, wearable devices, desktops, laptops, servers, etc.), or that are in operable communication via wired (internet protocol, etc.) or wireless formats (Wi-Fi, Bluetooth™, IEEE 802.11 formats, cellular communication data formats (GPRS, 3G, 4G (Mobile WiMAX, LTE, etc.), or optical, etc.) with one or more devices or processors. In one embodiment, one or more of the devices (such as a portable device for example) communicates this information to another device (such as a server). The decision information or information used to generate decision information may be stored on a non-transitory computer-readable media on or in operable communication with the portable or wearable device, a remote computer or server (such as an insurer's computer or the insured's computer, for example), or an automobile or craft or device operatively connected thereto.

Data from the Individual

In one embodiment, decision information or information used to generate decision information is supplied by the individual. In this embodiment, the individual may supply the decision information or information used to generate decision information in one or more of the following situations: during the creation of the initial underwriting profile (such as an initial test or survey), subsequent to the creation of the initial underwriting profile (such as a subsequent test or survey); upon request by the underwriter for information directly or indirectly related to one or more aspects of the decision information; and by allowing the underwriter access to one or more data providers (such as postings by the individual on a social networking website or text, image, or video messages sent using the individual's portable or wearable device or an email account).

### Portable or Wearable Device

In one embodiment, decision information or information used to determine decision information is obtained from a portable device or wearable device. In one embodiment, the portable device or wearable device is a device readily transported by a single person and capable of providing computing operations. In one embodiment, the portable device or wearable device is a cellular phone, smartphone, personal data assistant (PDA), personal navigation device (PND) such as a GPS system, tablet computer, watch (such as a smart watch), a wearable computer, a personal display system, a personal portable computer, a laptop, head-mounted display, eyeglass display, eyewear display, contact lens with sensors, pocket computer, pocket projector, miniature projector, wireless transmitter, microprojector, headphone device, earpiece device, mobile health device or fitness band capable of storing, receiving, or transmitting health related information, handheld device, accessory of another portable device; or other computing device that can be transported or worn by a person.

In one embodiment, the portable or wearable device comprises one or more functional features. The one or more functional features include one or more selected from the group: display, spatial light modulator, indicator, projector, touch interface, touchscreen, finger print reader, eye tracking sensor, keyboard, keypad, button, roller, sensors, radio transceiver or receiver, speaker, microphone, camera, user interface component, headphones, and wireless or wired communication feature (such as wireless headphone, Bluetooth™ headset, wireless user interface, or other device or vehicle wirelessly communicating with the portable device).

### Sensors and Components

In one embodiment, the portable device, wearable device, vehicle or craft (such as an aircraft, watercraft, or land craft), building, structure, or computing device operatively connected to a network directly or indirectly communicates to the individual, a second device, or the underwriter decision information or information that can be used to generate decision information obtained stored on one or more non-transitory computer-readable media obtained from one or more sensors. In another embodiment, the portable device, wearable device, vehicle, craft, building, structure, or computing device operatively connected to a network comprises one or more devices selected from the group: antenna, a Global Positioning System (GPS) sensor (which may include an antenna tuned to the frequencies transmitted by the satellites, receiver-processors, and a clock), accelerometer (such as a 3D accelerometer), gyroscope (such as a 3D gyroscope), touch screen, button or sensor, temperature sensor, humidity sensor, proximity sensor, pressure sensor, blood pressure sensor, heart rate monitor, ECG monitor, magnetoencephalography device, body temperature sensor, blood oxygen sensor, body fat percentage sensor, stress level sensor, respiration sensor, biometric sensor (such as a fingerprint sensor or iris sensor), facial recognition sensor, eye tracking sensor, acoustic sensor, security identification sensor, altimeter, magnetometer (including 3D magnetometer), digital compass, photodiode, vibration sensor, impact sensor, free-fall sensor, gravity sensor, motion sensor (including 9 axis motion sensor with 3 axis accelerometer, gyroscope, and compass), IMU or inertial measurement unit, tilt sensor, gesture recognition sensor, eye-tracking sensor, gaze tracking sensor, radiation sensor, electromagnetic radiation sensor, X-ray radiation sensor, light sensor (such as a visible light sensor, infra-red light sensor, ultraviolet light sensor, photopic light sensor, red light sensor, blue light sensor, and green light sensor), microwave radiation sensor, back illuminated sensor (also known as a backside illumination (BSI or BI) sensor), electric field sensor, inertia sensor, haptic sensor, capacitance sensor, resistance sensor, biosensor, barometer, barometric pressure sensor, radio transceiver, Wi-Fi transceiver, Bluetooth™ transceiver, cellular phone communications sensor, GSM/TDMA/CDMA transceiver, near field communication (NFC) receiver or transceiver, camera, CCD sensor, CMOS sensor, surveillance camera, thermal imaging camera, microphone, voice recognition sensor, voice identification sensor, gas sensor, smoke detector, carbon monoxide sensor, electrochemical gas sensor (such as one calibrated for carbon monoxide), gas sensor for oxidizing gases, gas sensor for reducing gases, breath sensor (such as one detecting the presence of alcohol), glucose sensor, environmental sensor, and pH sensor. The information from one or more sensors may be stored on a non-transitory computer-readable media on or in operable communication with the portable or wearable device, a remote computer or server (such as an insurer's computer or the insured's computer, for example), or an automobile or craft or device operatively connected thereto.

Data from External Sources

In one embodiment, decision information or information used to determine decision information is obtained from an external data provider, an external data source, or an external network. External sources include data sources external to the individual such as social networks, cellular service provider networks, internet connection suppliers, email hosting service providers, website hosting service providers, government networks (such as police or homeland security networks), security camera networks, weather data networks or providers, credit card companies, geographic data providers or networks, healthcare provider network, Internet audience data aggregator or provider, internet-based services provider (such as Google Inc., Microsoft Inc., Yahoo Inc., Apple Inc., etc.), an online or brick-and-mortar merchant (such as Apple, a chain of liquor stores, a grocery store, Amazon.com, etc.), and other networks or data sources comprising information related to the individual, decision information, or information used to determine decision information.

### Identifying Risk-Related Situations

In one embodiment, one or more risk-related situations are identified using decision information from one or more data sources. In one embodiment, contextual decision information is used to identify risk-related situations where there is a possibility of a loss such as injury or death, property damage, vehicle damage, missing one or more loan payments, loss of job or income, or other real or perceived loss of value of a tangible or intangible item (such as a loss in company brand approval).

### Decision-Making Process Algorithm

In one embodiment, a decision-making process algorithm is executed on one or more processors in a system to determine or process decision information for determining the risk assessment, the risk score, the underwriting, or the cost of insurance for an individual. In one embodiment, the decision-making algorithm performs one or more of the tasks selected from the group: identifies a risk-related decision; determines decision information; determines (with or without a degree of certainty or probability) contextual decision related information (such as the framework for the decision); determines (with or without a degree of certainty or probability) risk exposure information; determines (with or without a degree of certainty or probability) the use of one or more decision-making processes by the individual; determines (with or without a degree of certainty or probability) the use of one or more heuristic decision-making processes by the individual; determines the decision outcome; determines whether it is a negative, positive, or neutral decision outcome; correlates the actual or perceived risk exposure information with one or more decision-making processes (such as a heuristic); identifies the decision and/or the individual on a scale from risk-seeking to risk-avoiding; analyzes historical decision information to provide decision information for a subsequent decision (such as a vehicle operator frequently choosing a particular decision-making process under a particular set of conditions); compares decision information for an individual with collective decision information from a plurality of individuals; identifies one or more patterns in decision information from a plurality of individuals; applies an identified pattern of decision related information from a plurality of individuals to determine, predict, or estimate the decision information for individual (including an individual within or not within the plurality of individuals). The decision making algorithm may be stored on a non-transitory computer-readable media on or in operable communication with the portable or wearable device, a remote computer or server (such as an insurer's computer or the insured's computer, for example), or an automobile or craft or device operatively connected thereto. The decision making algorithm may be processed by one or more processors on or in operable communication with the portable or wearable device, a remote computer or server (such as an insurer's computer or the insured's computer, for example), or an automobile or craft or device operatively connected thereto.

### Baseline Heuristic Patterns and Cognitive Mapping

In one embodiment, the use of one or more decision-making processes under a plurality of situations is analyzed for an individual or group of individuals. In another embodiment, the use of one or more heuristic decision-making processes under a plurality of situations is analyzed for an individual and/or group of individuals. By acquiring (directly or indirectly) baseline decision information or information used to determine decision information for an individual for different risk-related decision situations, the information may be analyzed for patterns and may be used to segment or classify an individual (such as segmenting the individual as risk-seeking, risk-averse, or some intermediate classification); determine a propensity for specific risk-related behavior (generalized or in specific situations); or predict the likelihood for a specific decision or decision outcome for one or more given situations. The baseline decision-making processes may be acquired in the initial underwriting profile generation; prior to underwriting using data sources; during a testing period (such as an electronic questionnaire prior to underwriting or during an initial evaluation for the underwriting); or in a trial or initial data capture phase prior to or in conjunction with the underwriting process. For example, initial baseline decision information may be captured to determine which baseline heuristic decision-making processes are used by an individual in specific conditions. The frequency, use in situations with similar characteristics, patterns of use, or use of a combination or likely combination of one or more heuristic decision-making processes may be used to provide risk-related information for determining the risk assessment, the risk score, the underwriting, or the cost of insurance for the individual.

Similarly, the baseline heuristics used by a plurality of individuals may be analyzed (possibly in conjunction with other information such as demographics, geographical information, or other information within an underwriting profile) to provide insight or guidelines for determining the baseline heuristic decision-making processes used by a specific individual in specific situations. For example, for a specific demographic of individuals (or individuals with similar characteristics), the use of a specific heuristic decision-making process may be identified as being the dominant decision-making process used in specific situations. Information that may be used to construct a baseline heuristic pattern for one or more individuals may include decision information provided by the individual; decision information derived or inferred from information provided by the individual; contextual information; actual or perceived risk exposure information; decision information from one or more data sources; decision information derived from analysis of decision information from other individuals; patterns or relationships inferred from decision information analyzed for a plurality of individuals; or historical information from one or more of the aforementioned sources.

### Cognitive Map for an Individual

As used herein, a cognitive map is a map or catalogue of an individual's cognitive information or data including cognitive capacity, current cognitive load, cognitive skills, cognitive speed, and/or cognitive processes especially as they pertain to making decisions. The cognitive map comprises cognitive information and the cognitive map may be represented by one or more data sets, one or more arrays of data, one or more databases, or other collection of data stored on a non-transitory computer-readable media.

The cognitive processes include decision-making processes such as heuristic or analytical decision-making processes. The cognitive information may be mapped for different situations and may include statistical information related to the probability of use of one or more cognitive processes in specific (or generalized) situations. For example, the cognitive map may include information indicating that the individual uses the heuristic decision-making process of overconfidence 80% of the time when they are operating a vehicle and running late for an event. The cognitive map may further include statistical information that correlates one or more decision-making processes and decision outcomes for one or more situations. This correlated information may further include an assessment of the level of risk associated with the one or more decision-making processes or a generalized risk assessment (from risk-seeking to risk-averse, for example) of the individual based on the correlations. The cognitive map may include statistical information indicating the number, probability, propensity, or percentage of the risk-related decisions made by the individual that fall into risk-seeking or risk-averse categories.

In one embodiment, the cognitive map includes historical cognitive information such as cognitive capacity, cognitive skills, cognitive speed, cognitive load, or cognitive processes. The historical cognitive information may be used, for example, to determine which heuristic decision-making processes the individual uses in risk-related situations in general or in specific situations. In another embodiment, the historical cognitive information is analyzed to determine correlations, patterns, or relationships between risk-related decision-making processes and the resulting decision outcomes. In this embodiment, the historical cognitive information can be used to identify or categorize decision information for a specific current situation, predict decision information for a specific future situation (real or hypothetical), or determine a propensity for a specific risk-related decisions for a specific future situation (real or hypothetical). New information may be added to the cognitive map in one or more time intervals selected from the group: real-time, within a minute, within an hour, within a day, within a week, within a month, within a quarter, twice a year, yearly, every two years, and within a multi-year timespan. In one embodiment, new information is added to the cognitive map after identification of new information from one or more specific events; new environmental or individual condition information; new individual decisions, new individual decision outcomes, new input information from external sources, new information from a particular data source, new risk or loss exposure information, or new specific contextual information. As used in this context, “new information” refers to information not previously in the cognitive map and may include information that has recently changed, recently acquired information from recent events, historical information acquired from a new data source, or new prediction or calculated information, for example. In another embodiment, the adjustment is made at one or more specific times determined by an individual, an underwriter, or a third-party.

In one embodiment, cognitive information in a cognitive map for an individual is adjusted or changed by providing feedback information, providing direction or guidance, providing encouragement, or directly modifying the behavior of an individual such that for one or more situations their behavior changes, choice of using one or more risk-related decision process changes, or more decisions result in a positive decision outcomes or fewer negative decision outcomes.

### Cognitive Maps for Multiple Individuals

In one embodiment, a method of generating a risk score, a risk assessment, a cost of insurance, or a risk score and a cost of insurance for at least one individual based at least in part on risk-related decision-making processes and resulting decision outcomes comprises correlating the risk-related decision-making processes and the decisions with the resulting decision outcomes using a plurality of cognitive maps. The cognitive maps for multiple individuals comprising cognitive information may be represented by one or more data sets, one or more arrays of data, one or more databases, or other collection of data stored on a non-transitory computer-readable media.

In this embodiment, a collection of cognitive maps may be analyzed to determine statistical correlations between the probabilities of use of one or more cognitive processes in specific (or generalized) situations by a specific group of individuals. For example, by analyzing 5,000 cognitive maps, one may determine a statistically high correlation between the use of the “group think” heuristic decision-making process (where decisions conform to the opinion of the group) and members of a socially interconnected group with very active postings on social networking websites suggesting risk-seeking preferences or behavior. In this example, by further statistically correlating the “group think” heuristic decision-making process (in general or for a particular group of individuals) with a statistically high probability of negative decision outcomes, the cost of automobile insurance for an individual within this group may be increased to reflect the increased risk. In this example, the data sources for decision related information could include testing or survey data from the group members, telematics data from the group members, portable or wearable device use information, external data sources such as social networking websites (such as Google+ or Facebook), publicly available external data sources (including police records, credit reporting agencies, and internet resources), and other data sources.

In another embodiment, the plurality of cognitive maps may be used to determine the probability for an individual of using one or more specific decision-making processes (such as one or more specific heuristic decision-making processes) in a specific situation. In this embodiment, risk-related decision information in a plurality of cognitive maps can be analyzed to determine the probability, such as for example, based on patterns, correlations, or relationships for decision information.

In another embodiment, the plurality of cognitive maps may be used to classify one or more individuals into groups. The classification may be based on one or more selected from the group: risk information, individual information, behavioral information, decision information such as common or similar risk-related decision information, contextual information, risk exposure information, cognitive information, traits, physical or mental condition, personalities, preferences, personal characteristic information, level of the risk behavior from risk-seeking to risk-averse, social connections with other individuals, location, credit score, or other demographic information.

In another embodiment, the plurality of cognitive maps may be used to characterize the level of risk associated with the use of one or more specific risk-related decisions (such as one or more specific heuristic risk-related decision-making processes). In this embodiment, decision information (such as the use of one or more specific risk-related decisions) may be correlated with the corresponding decision outcomes from multiple cognitive maps to determine the risk associated with the decision information. For example, an 85% correlation of the use of an affect heuristic decision-making process with a negative decision outcome for a specific group of individuals in specific conditions can characterize the affect heuristic decision-making process as a high risk decision-making process and can contribute to the classification of the individual as a risk-seeking individual and increase their rates for insurance.

In one embodiment, the cognitive information for a group of individuals is stored in a single cognitive map or a collection of cognitive maps. A cognitive map for a single individual, a collection of cognitive maps for a group of individuals, or a single cognitive map for a group of individuals comprises cognitive information that may be stored on one or more non-transitory computer-readable media that are connected or in communication with one or more devices (including portable devices, wearable devices, desktops, laptops, servers, etc.), or that are in operable communication via wired (internet protocol, etc.) or wireless formats (Wi-Fi, Bluetooth™, IEEE 802.11 formats, cellular communication data formats (GPRS, 3G, 4G (Mobile WiMAX, LTE, etc.), or optical, etc.) with one or more devices or processors. In one embodiment, one or more of the devices (such as a portable device for example) communicates cognitive information from one or more cognitive maps to another device (such as a server). The cognitive maps comprise cognitive information that may be stored on a non-transitory computer-readable media on or in operable communication with the portable or wearable device, a remote computer or server (such as an insurer's computer or the insured's computer, for example), or an automobile or craft or device operatively connected thereto.

Correlating the Risk-Related Decision-Making Processes and the Decisions with the Resulting Decision Outcomes

In one embodiment, a method of generating a risk assessment, a risk score, an underwriting, or a cost of insurance comprises correlating the risk-related decision-making processes and the decisions with the resulting decision outcomes for an individual. In one embodiment, the risk-related decision information for decisions made by one or more individuals is examined and statistical relationships are determined between decision-making processes, decisions, and the decision outcomes. In one embodiment, correlations may be determined using cognitive information or decision information from one or more cognitive maps, which may include a cognitive map for the individual. The correlation may be performed prior as part of a process for generating an initial risk assessment, risk score, underwriting, or cost of insurance. In another embodiment, the correlation is performed after the generation of an initial underwriting profile, after the generation of baseline heuristic patterns, or after the generation of an initial cognitive map.

In on embodiment, an algorithm that correlates the risk-related decision-making processes and the decisions with the resulting decision outcomes for an individual is stored on a non-transitory computer-readable media on or in operable communication with the portable or wearable device, a remote computer or server (such as an insurer's computer or the insured's computer, for example), or an automobile or craft or device operatively connected thereto. The algorithm that correlates the risk-related decision-making processes and the decisions with the resulting decision outcomes for an individual may be executed by one or more processors on or in operable communication with the portable or wearable device, a remote computer or server (such as an insurer's computer or the insured's computer, for example), or an automobile or craft or device operatively connected thereto.

Using Statistical Data from Cognitive Maps to Determine Probabilities, Associations, and Correlations

In one embodiment, the cognitive information and decision information from one or more cognitive maps is used to create statistical data for determining which decision-making process (such as which heuristic decision-making process) is more accurate (or less accurate) for predicting negative and/or positive decision outcomes. In one embodiment, the statistical correlation for a plurality of decision-making processes is analyzed correlations that are associated with loss, negative decision outcomes, lack of loss, or positive decision outcomes is used to generate the risk assessment, the risk score, the underwriting, or the cost of insurance. In one embodiment, predictive analytics are used to analyze the information. The correlations may be negative correlations or positive correlations.

### Negative Correlations

In one embodiment, the cognitive information and decision information from one or more cognitive maps is used to create statistical data for determining which decision-making processes are more accurate for predicting a negative correlation. As used herein, a negative correlation for a decision-making process is where the increased use of one or more decision-making processes correlates with decrease in positive outcomes (or an increase in negative decision outcomes). The use by an individual of one or more decision-making processes with a negative correlation can increase the risk and result in an increased risk assessment, increased risk score, an underwriting with more negative terms, or a an increase in the cost of insurance.

### Positive Correlations

In one embodiment, the cognitive information and decision information from one or more cognitive maps is used to create statistical data for determining which decision-making processes are more accurate for predicting a positive correlation. As used herein, a positive correlation for a decision-making process is where the increased use of one or more decision-making processes correlates with increase in positive outcomes (or a decrease in negative decision outcomes). The use by an individual of one or more decision-making processes with a positive correlation can decrease the risk and result in an decreased risk assessment, decreased risk score, an underwriting with more positive terms, or a an decrease in the cost of insurance.

Risk-Seeking or Risk-Averse Profile

In one embodiment, a method of generating the risk assessment, the risk score, the underwriting, or the cost of insurance for an individual comprises profiling the individual such that they are categorized on a scale from very risk-seeking individual to a very risk-averse individual. In one embodiment, decision information such as contextual information is used to determine the level of risk associated with one or more risk-related decisions made by the individual. In one embodiment, the individual risk profile includes risk-related information, such as a characterization of the individual on a scale from very risk-seeking to very risk-averse for one or more individuals and may be generated for different situation (where for example, the individual may be categorized on a risk scale differently for different situations or conditions). In one embodiment, the risk profile for one or more individuals is classified as either being more type one (automatic) or type two (reflective) for the types of risks being underwritten and scales can be developed based on the varying degree to which an individual uses one type of decision system over the other. Additional risk profile categories can be created based on variations in heuristic collections and cognitive maps for greater segmentation and risk scoring ability.

For example, over a period of a year, risk-related decision information for an individual obtained from one or more data sources is compiled into a cognitive map and analyzed. If from this analysis it is determined through numerous scenarios that when a first individual is running late for work, they tend to seek risk, they may be categorized in a risk profile as risk-seeking for the purpose of calculating a cost of automobile insurance.

Similarly, in another example, over a period of a year, risk-related decision information for an individual obtained from one or more data sources is compiled into a cognitive map and analyzed. If from this analysis it is determined through numerous scenarios that when a first individual is under a significant amount of pressure (physiological and/or mental pressure) they tend to seek risk, they may be categorized in a risk profile as risk-seeking for the purpose of calculating a cost of automobile insurance.

### Predictive Model

In one embodiment, a method of generating the risk assessment, the risk score, the underwriting, or the cost of insurance for an individual comprises using a predictive model. As used herein, a predictive model is a mathematical model used to predict risk outcomes based on a retrospective analysis of factors and their correlations to actual outcomes. In one embodiment, the predictive model uses predictive analytics to determine which decision-making process is better at predicting negative decision outcomes and/or positive decision outcomes. In another embodiment, the predictive model includes one or more processes selected from the group: deriving or acquiring loss information (such as from the decision outcome information); correlating the loss information with the decision-making process and corresponding decision outcomes to derive a correlation coefficient; and generating a weighted model for factoring in more than one correlation between the decision-making process, corresponding decision outcomes, and loss information.

In one embodiment, a method of generating a risk assessment, a risk score, an underwriting, or a cost of insurance for an individual for a specific set of conditions (such as a specific occasion or a specific automobile trip, for example) comprises using a predictive model that includes correlating one or more risk-related decision-making processes and the decisions with the resulting decision outcomes. In another embodiment, a method of generating a risk assessment, a risk score, an underwriting, or a cost of insurance for an individual includes adjusting the risk assessment, the risk score, the underwriting, or the cost of insurance for an individual at a first frequency using a predictive model that includes correlating one or more risk-related decision-making processes and the decisions with the resulting decision outcomes. In a further embodiment, a method of generating a risk assessment, a risk score, an underwriting, or a cost of insurance is updated in real-time, on-demand (from the individual or the underwriter), or when the specific situation changes using a predictive model that includes correlating one or more risk-related decision-making processes and the decisions with the resulting decision outcomes. In one embodiment, the predictive model is incorporated into a predictive model algorithm that is stored on a non-transitory computer-readable media on or in operable communication with the portable or wearable device, a remote computer or server (such as an insurer's computer or the insured's computer, for example), or an automobile or craft or device operatively connected thereto. The predictive model algorithm may be executed by one or more processors on or in operable communication with the portable or wearable device, a remote computer or server (such as an insurer's computer or the insured's computer, for example), or an automobile or craft or device operatively connected thereto. In another embodiment, the predictive model algorithm is incorporated into the decision-making process algorithm.

### Propensity Model

In one embodiment, a method of generating the risk assessment, the risk score, the underwriting, or the cost of insurance for an individual comprises using a propensity model. As used herein, a propensity model is a mathematical model that prospectively determines an outcome or desired outcome given a certain set of conditions or a certain set of conditions in conjunction with a set of influencing factors. In one embodiment, the propensity model prospectively determines specific outcomes based on applying generalized or individualized risk profiles to a set of conditions to calculate the probability of an individual taking a particular action or producing a particular outcome. These probabilities may be used to determine the risk assessment, the risk score, the underwriting, or the cost of insurance

In one embodiment, heuristics and cognitive maps are used to develop propensity models that can predict a person's risk-seeking or risk-averse actions given a set of conditions or particular context. In one embodiment, risk-related decision information (such as contextual information, cognitive information, and/or risk or loss exposure information for a situation) for an individual is input into a propensity model to determine the probability of an individual making a risk-related decision that results in a negative decision outcome or positive decision outcome for the situation. In another embodiment, risk-related decision information (such as contextual information, cognitive information, and/or risk or loss exposure information for a situation) for a group of individuals is input into a propensity model to determine the probability of one or more individuals making a risk-related decision that results in a negative decision outcome or positive decision outcome for the situation. In one embodiment, the propensity model is incorporated into a propensity model algorithm that is stored on a non-transitory computer readable medium on or in operable communication with the portable or wearable device, a remote computer or server (such as an insurer's computer or the insured's computer, for example), or an automobile or craft or device operatively connected thereto. The propensity model algorithm may be executed by one or more processors on or in operable communication with the portable or wearable device, a remote computer or server (such as an insurer's computer or the insured's computer, for example), or an automobile or craft or device operatively connected thereto. In another embodiment, the propensity model algorithm is incorporated into the decision-making process algorithm.

### Predictive Factors

In one embodiment, method of generating the risk assessment, the risk score, the underwriting, or the cost of insurance for an individual comprises using positive and/or negative predictive factors that have a direct or indirect influence on generating positive decision outcomes or negative decision outcomes. In one embodiment, the method of generating the risk assessment, the risk score, the underwriting, or the cost of insurance for an individual comprises includes one or more of the steps using predictive factors selected from the group: identifying one or more positive predictive factors or negative predictive factors from the decision information (such as contextual information); correlating one or more positive predictive factors or negative predictive factors with negative decision outcomes or positive decision outcomes; providing feedback (such as risk-related decision information feedback) related to one or more the predictive factors to the individual; inducing and/or encouraging the individual to modify their behavior or their use of one or more risk-related decision processes (such as through punishment, reward, negative reinforcement, or positive reinforcement) to achieve one or more positive decision outcomes and/or eliminate one or more negative decision outcomes; and providing direction and/or resources for the individual to modify their behavior or their use of one or more risk-related decision processes to achieve one or more positive decision outcomes and/or eliminate one or more negative decision outcomes. In another embodiment, a method of behavior modification uses one or more of the aforementioned steps using predictive factors. In a further embodiment, a method of providing feedback to an individual uses one or more of the aforementioned steps using predictive factors.

### Negative Predictive Factors

In one embodiment, one or more negative predictive factors are identified and used for generating the risk assessment, the risk score, the underwriting, or the cost of insurance for an individual. As used herein, negative predictive factors are factors that are correlated to a negative decision outcome or negative outcome (such as a loss). For example, in the context of providing automobile insurance, running late for work (contextual information that is a negative predictive factor) and deciding to speed may result in the car accelerating beyond the speed limit and having an increased likelihood of having an accident (negative decision outcome) such that the vehicle could crash (negative outcome and loss).

In one embodiment, a method of generating the risk assessment, the risk score, the underwriting, or the cost of insurance for an individual comprises identifying one or more negative predictive factors and correlating the one or more negative predictive factors with one or more negative decision outcomes or negative outcomes. In another embodiment, this method further comprises one or more steps selected from the group: providing feedback to the individual related to the one or more negative predictive factors; inducing and/or encouraging the individual (such as through punishment, reward, negative reinforcement, or positive reinforcement) to modify their behavior or their use of one or more risk-related decision processes to achieve one or more positive decision outcomes and/or eliminate one or more negative decision outcomes; or providing direction and/or resources for the individual to modify their behavior or their use of one or more risk-related decision processes to achieve one or more positive decision outcomes and/or eliminate one or more negative decision outcomes.

For example, in the context of automobile insurance, by analyzing data from portable devices and telematics devices in a vehicle, it is determined that when a specific individual uses a social networking site before leaving home in the morning they have a higher likelihood of being late for work, and that when they are running late for work (contextual information) they have a higher incidence of speeding. In this example, running late for work is identified as a negative predictive factor for a decision to speed and an increased likelihood of having an accident (negative decision outcome). In this example, the individual may be encouraged to change their behavior when the indirect action (using the social networking application in the morning before work) results in the negative factor (running late for work) that results in a higher incidence of deciding to speed and increased likelihood of having an accident (negative decision outcome). For example, software on the individual's portable device may generate a notification (feedback) suggesting that the individual use the application later so that they are not late for work when they try to open a social networking site on the portable device in the morning before leaving for work.

In one embodiment, cognitive information is analyzed to determine one or more correlations between the cognitive information and negative decision outcomes or negative outcomes. These correlations are negative cognitive predictive factors. In one embodiment, the one or more negative cognitive predictive factors are used to provide feedback, encourage behavior, modify behavior, or provide direction and/or resources for the individual to modify their behavior.

### Positive Predictive Factors

In one embodiment, one or more positive predictive factors are identified and used for generating the risk assessment, the risk score, the underwriting, or the cost of insurance for an individual. As used herein, positive predictive factors are factors that are correlated to a positive decision outcome or positive outcome (such as no loss or loss prevention). For example, in the context of providing automobile insurance, a decision to pull over to take a phone call or call a person back instead of answering a call (positive factors) may result in safe operation of a vehicle and reduced likelihood of having an accident (positive decision outcome) such that the vehicle safely completes a trip without incident (positive outcome and no loss).

In one embodiment, a method of generating the risk assessment, the risk score, the underwriting, or the cost of insurance for an individual comprises identifying one or more positive predictive factors and correlating the one or more positive predictive factors with one or more positive decision outcomes or positive outcomes. In another embodiment, this method further comprises one or more steps selected from the group: providing feedback to the individual related to the one or more positive predictive factors; inducing and/or encouraging the individual (such as through punishment, reward, negative reinforcement, or positive reinforcement) to modify their behavior or their use of one or more risk-related decision processes to achieve one or more positive decision outcomes and/or eliminate one or more negative decision outcomes; or providing direction and/or resources for the individual to modify their behavior or their use of one or more risk-related decision processes to achieve one or more positive decision outcomes and/or eliminate one or more negative decision outcomes.

For example, in the context of automobile insurance, by analyzing data from a cellphone and telematics device in a vehicle, one can determine that when an individual operating a vehicle decides to pull over to send a text message on their cellphone (positive predictive factor) they have a decreased likelihood of having an accident (positive decision outcome). In this example, the individual may be encouraged to continue their positive predictive factor behavior of pulling over to send a text message to decrease the likelihood of having an accident. For example, software on the individual's phone may generate a notification (feedback) suggesting that the individual pull over after starting a text message application on a phone while operating a vehicle. Also, after pulling over and completing a text message, a notification (feedback) may appear on the phone thanking the individual for the safe behavior.

In one embodiment, cognitive information is analyzed to determine one or more correlations between the cognitive information and positive decision outcomes or positive outcomes. These correlations are positive cognitive predictive factors. In one embodiment, the one or more positive cognitive predictive factors are used to provide feedback, encourage behavior, modify behavior, or provide direction and/or resources for the individual to modify their behavior. For example, in one embodiment a positive correlation is identified between individuals who tend to be better than most at a specific discipline or skill (such as cognitive capacity or mental focus) and safe driving. In this example, an insurance underwriter may set-up an award or discount program for the cost of automobile insurance for individuals who improve their performance in a specific discipline or skill (such as an improvement cognitive capacity through the use of cognitive enhancement games or puzzles) and expect to see an improvement in safe vehicle operation by the individual over time. In one embodiment, a resource may be provided to the individual to help modify their behavior and/or improve their cognitive ability. The resource may include training (such as risk avoidance training, for example), an application, seminar, instructional media, a game, a puzzle, cognitive enhancement application or tool, behavior modification application or tool, or other resource known to modify behavior and/or facilitate enhancement of cognitive ability. For example, a free mathematical puzzle application for a smartphone (such as a Sudoku application) may be offered to the individual and after installing opening the application, the individual's identity is verified (such as by using the built-in camera and facial recognition), and improved puzzle performance is rewarded by discounts to their automobile insurance.

### Punishment and Reward System

In one embodiment, a punishment system and/or reward system is used to modify the behavior of an individual. A punishment system may be used to modify the behavior of individuals exhibiting risk-seeking behavior and/or a reward system may be used to modify the behavior of individuals exhibiting risk-averse behavior.

In one embodiment, a method of determining or providing a risk assessment, a risk score, an underwriting, a cost of insurance, or a reward or punishment for an individual with insurance comprises one or more punishment systems or reward systems selected from the group:

punishment (or negative reinforcement) for continued use of negative predictive factors; punishment (or negative reinforcement) for discontinuing use of positive predictive factors; punishment (or negative reinforcement) for a reduction in activities that lead to positive predictive factors; punishment (or negative reinforcement) for an increase in activities that lead to negative predictive factors; reward (or positive reinforcement) for continued use of positive predictive factors; reward (or positive reinforcement) for discontinuing use of negative predictive factors; reward (or positive reinforcement) for a reduction in activities that lead to negative predictive factors; and reward (or positive reinforcement) for an increase in activities that lead to positive predictive factors.

In one embodiment, the punishment or negative reinforcement includes one or more selected from the group: increase in the cost of insurance, absence of positive feedback, negative feedback, a financial fee or penalty, restriction of one or more activities (such as restricting the use of a specific software application while operating a vehicle or at other times), notification of an individual (such as a parent) of a negative decision outcome, notification of a company or organization (such as the insurance underwriter or government organization) of a decision related information such as a negative decision outcome, cancellation or negative modification of the insurance policy, and requiring specific actions before continuing the insurance policy or before reducing the cost of insurance that may have increased (such as requiring specific training or completion of specific tasks).

In another embodiment, the reward or positive reinforcement includes one or more selected from the group: decrease in the cost of insurance, positive feedback, a financial credit or discount, removal of a restriction of one or more activities (such as allowing the use of a specific software application while operating a vehicle or at other times), notification of an individual (such as a parent) of decision related information such as a positive decision outcome, notification of a company or organization of a positive decision outcome (such as the insurance underwriter or government organization), continuation or positive modification of the insurance policy, and not requiring specific actions before continuing the insurance policy or before reducing the cost of insurance that may have increased (such as not requiring specific training or not requiring completion of specific tasks).

### Feedback to the Individual

In one embodiment, a method of generating a risk score, a cost of insurance, or a risk score and a cost of insurance for at least one individual includes providing feedback to the individual through one or more methods that make the individual aware of one or more risk-taking behaviors. In one embodiment, the method of providing feedback includes one or more selected from the group: visual notification (such as on a portable device display), auditory notification (such as a portable device providing an audible alert), sensory notification (such as the portable device vibrating), and an indirect notification (such as allowing or disallowing the use of an portable device software application or feature). The form or delivery of the feedback may take many forms, such as an SMS text message; email, pop-up notification; an application changing the display to indicate a representation of feedback; a web based application or a report with results and/or analysis of recent risk-related behavior negative predictive factors, negative decision outcomes, negative outcome information, or other decision information; suggestions or directions for improvement or behavior modification; provided in real-time; provided at regular intervals; or provided after a specific triggering event.

In one embodiment, the feedback to the individual is determined and/or executed using a feedback algorithm that is stored on a non-transitory computer readable medium on or in operable communication with the portable or wearable device, a remote computer or server (such as an insurer's computer or the insured's computer, for example), or an automobile or craft or device operatively connected thereto. The feedback algorithm may be executed by one or more processors on or in operable communication with the portable or wearable device, a remote computer or server (such as an insurer's computer or the insured's computer, for example), or an automobile or craft or device operatively connected thereto. In another embodiment, the feedback algorithm is incorporated into the decision-making process algorithm.

### Behavior Modification

In one embodiment, a method of generating a risk score, a cost of insurance, or a risk score and a cost of insurance for at least one individual includes directly or indirectly encouraging, inducing, or providing resources for modifying the behavior of the individual. In one embodiment, the behavior modification occurs through one or more selected from the group: providing feedback information for conditioning; negative reinforcement; punishment; positive reinforcement; reward; cognitive enhancement (such as (directly or indirectly) engaging in cognitive enhancement activities that could improve cognitive ability or decision-making capabilities); inducement; encouragement; providing resources to enable certain behaviors or providing specific activities that remove or change negative predictive factors (or activities that result in the negative predictive factor) or increase or continue the use of positive predictive factors (or activities that result in positive predictive factors); exposure to possible loss consequences (such as showing or providing access to videos of individuals that have experienced a loss, informative media, or statistical information); training, games, or other activities that improve judgment or perceptions skills (including depth perception, time perception, speed perception, risk recognition, danger recognition, risk exposure recognition, or alternative action recognition); increased exposure to safe methods, activities or equipment that improves safety or reduces risk (such as training videos or other media, testimonials in the form of video or other media, safety-related product information including product discounts or incentives, or statistical information); or exposure to information related to the behavior of others (such as safe activity of friends or family).

In one embodiment, the behavior modification is determined and/or executed using a behavior modification algorithm that is stored on a non-transitory computer readable medium on or in operable communication with the portable or wearable device, a remote computer or server (such as an insurer's computer or the insured's computer, for example), or an automobile or craft or device operatively connected thereto. The behavior modification algorithm may be executed by one or more processors on or in operable communication with the portable or wearable device, a remote computer or server (such as an insurer's computer or the insured's computer, for example), or an automobile or craft or device operatively connected thereto. In another embodiment, the behavior modification algorithm is incorporated into the decision-making process algorithm and/or a feedback algorithm.

Segmentation of the Individual into a Risk Group

In one embodiment a method of generating a risk score, a cost of insurance, or a risk score and a cost of insurance for at least one individual comprises segmenting the individual into a risk group or tier. The segmentation may use decision information, cognitive information, the initial underwriting profile, or one or more correlations between the risk-related decision-making processes and the decisions with the resulting decision outcomes for the individual.

In one embodiment, the individual is segmented into a risk group based on the use of one or more risk-related decision-making processes in one or more situations. In another embodiment, the individual is segmented into a risk group based on where they fall on a scale from risk-seeking to risk-averse based on one or more correlations between the risk-related decision-making processes used by the individual and the decisions with the resulting decision outcomes. In another embodiment, the individual is segmented according to one or more risk scores, risk scales, or risk-related categories.

In another embodiment, the individual is segmented into a group based on whether the person tends to be System 1 dominant (reflexive or automatic) or System 2 dominant (reflective, concentrating, or analytical) for their decision-making processes in risk-related situations. In one embodiment, the individual is classified or segmented into a risk group based on the measured or inferred preference, dominance, or relative proportion of System 1 decision-making processes to System 2 decision-making processes used in one or more risk-related situations. Other decision information such as individual characteristics (mental, physical, intellectual, etc.), cognitive information, contextual information, risk exposure information, or correlations may be used in combination with the measured or inferred relative use of System 1 decision-making processes compared to System 2 decision-making processes in risk-related situations to generate a risk score, a cost of insurance, or a risk score and a cost of insurance. For example, in one embodiment, an individual who uses System 2 decision-making processes more than System 1 decision-making processes in risk-related situations and has a relatively large cognitive capacity and/or intelligence may have a reduced risk and cost of automobile insurance relative an individual who uses more System 1 decision-making processes than System 2 decision-making processes in risk-related situations with other risk factors being similar. The analysis of the use of System 1 or System 2 decision-making processes may performed for different risk-related situations and the method of generating a risk score, a cost of insurance, or a risk score and a cost of insurance for the individual may incorporate weighting the level of risk associated with the use of System 1 or System 2 decision-making processes for different risk-related situations.

In another embodiment, the individual is segmented into a risk group based on the predictive model or the propensity model. In one embodiment, the individual is initially segmented into a risk group based on their initial baseline heuristics patterns. In a further embodiment, the individual is segmented into a risk group based on their cognitive information in their cognitive map. In another embodiment, the individual is segmented into a risk group based on one or more criteria, such as commonly known in the insurance industry.

### Types of Risk Evaluation or Insurance

In one embodiment a risk assessment, a risk score, an underwriting, or a cost of insurance includes correlating one or more risk-related decision-making processes and resulting decision outcomes for risk-related decisions made by at the least one individual related to the type of insurance or type of type of risk assessment. In one embodiment, the risk assessment, risk score, underwriting or cost of insurance is for one or more insurance products selected from the group: casualty insurance, automobile or craft insurance, life insurance, health or medical insurance, property insurance, liability insurance, financial instrument insurance, and law enforcement risk assessment or regulation. In one embodiment, decision information, cognitive information, initial underwriting profile, or one or more correlations between the risk-related decision-making processes and the decisions with the resulting decision outcomes for the individual is used to provide a plurality of insurance products (such as home insurance and automobile insurance, for example) or the information is shared between different underwriters providing different insurance products. In one embodiment, a risk assessment, a risk score, an underwriting, or a cost of insurance is determined using a risk assessment algorithm, risk score algorithm, an underwriting algorithm, or a cost of insurance algorithm, respectively, that may be incorporated into the decision-making process algorithm and is stored on a non-transitory computer readable medium and executed on one or more processors on one or more devices.

### Casualty Insurance

In one embodiment, the risk assessment, risk score, underwriting, or cost of insurance is for casualty insurance. As used herein, casualty insurance can insure against accidents that are not necessarily connected with any specific property and includes automobile or other vehicle insurance, workers compensation, crime insurance, political risk insurance, earthquake insurance, terrorism insurance, fidelity and surety insurance.

In this embodiment, contextual information and/or risk-related decision information can include telematics information such as provided by an on-board diagnostic (OBD) system data source in an automobile (which may optionally be transmitted using a communication device such as a cellphone to a remote processor); geographic information, sensor information, feature or application use from a portable device; external data sources such contextual postings on social networking websites; or other information known to be used in the casualty insurance or automobile insurance industry for determining a risk score or cost of insurance. Other risk-related decision information that can be used to determine a casualty risk assessment, a casualty risk score, underwriting, or a cost of casualty insurance includes cognitive information, risk exposure information, the use of one or more decision-making or judgment processes, risk-related decisions, decision outcomes, and correlations between risk-related decision-making processes or judgments and the decisions or judgments made by the at least one individual in different risk-related situations.

### Automobile or Craft Insurance

In one embodiment, the risk assessment, risk score, underwriting, or cost of insurance is for vehicle or craft insurance (such as land craft (automobile insurance, truck insurance, etc.) water craft (marine insurance), or air craft (aviation insurance)). In this embodiment, contextual information and/or risk-related decision information can include telematics information such as provided by an on-board diagnostic (OBD) system data source or data recorder in the vehicle or craft (which may optionally be transmitted using a communication device such as from a cellphone to a remote processor); geographic information, sensor information, feature or application use from a portable device; information obtained from external data sources such as contextual postings on social networking websites, or other information known to be used in the automobile insurance industry or other craft insurance industry for determining a risk score or cost of insurance. Other risk-related decision information that can be used to determine a risk assessment, a risk score, underwriting, or a cost of insurance for vehicle or craft operation includes cognitive information, risk exposure information, the use of one or more decision-making or judgment processes, risk-related decisions, decision outcomes, and correlations between risk-related decision-making processes or judgments and the decisions or judgments made by the at least one individual in different risk-related situations.

### Distracted Driving

In one embodiment the risk assessment, risk score, underwriting, or cost of insurance for vehicle or transportation insurance includes monitoring one or more data sources for activities that are secondary or tertiary to operating a vehicle and using this contextual information to determine risk-seeking or risk-averse actions by the individual. In one embodiment, and one or more correlations between the risk-related decision-making processes and the decisions with the resulting decision for an individual under different cognitive loads is used to provide information for the risk assessment, risk score, underwriting, or cost for vehicle or transportation insurance.

### Health or Medical Insurance

In one embodiment, the risk assessment, risk score, underwriting, or cost of insurance is for health or medical insurance. In this embodiment, contextual information and/or decision related information can include health related decisions, condition of health, physical and mental age and condition, physical or mental activities and other information known to be used in the health or medical insurance industry for determining a risk score or cost of health or medical insurance. In one embodiment, the contextual information and/or decision related information can be obtained through data sources such as portable or wearable devices, portable or wearable health monitoring devices, activity monitoring devices (such as a smart watch that tracks running information), and external data sources such contextual postings on social networking websites.

### Life Insurance

In one embodiment, the risk assessment, risk score, underwriting, or cost of insurance is for life insurance. In this embodiment, contextual information and/or decision related information can include health related decisions, condition of health, physical and mental age and condition, physical or mental activities, information on risk-related activities (such as skydiving, scuba diving, sports, or hazardous work conditions), geographic location, travel information, the level of risk associated with the individual from risk-seeking to risk-averse for one or more activities, or other information known to be used in the life insurance industry for determining a risk score or cost of life insurance. In one embodiment, the contextual information and/or decision related information can be obtained through data sources such as portable or wearable devices, portable or wearable health monitoring devices, activity monitoring devices (such as a smart watch that tracks running information), and external data sources such contextual postings on social networking websites.

### Property Insurance

In one embodiment, the risk assessment, risk score, underwriting, or cost of insurance is for property insurance such as homeowners insurance or renters insurance. In this embodiment, contextual information and/or decision related information can include activity information related to maintenance or upkeep of the property, risk-related activities performed at the property or with the property (such as home parties attended by risk-seeking individuals and business use of the home or property), home condition assessments, and information from external data sources such as aerial photographs indicating use of swimming pools.

In one embodiment, the contextual information and/or decision related information can obtained through data sources such as home automation devices, home networking devices, home security monitoring devices, and other sensing devices such as smoke detectors, electrical system monitors, vibration sensors, wireless sensor networks, or thermostats and HVAC control devices.

### Liability Insurance

In one embodiment, the risk assessment, risk score, underwriting, or cost of insurance is for liability insurance such as professional liability insurance, director and officer liability insurance, and media liability insurance, for example. In this embodiment, contextual information and/or decision related information can include information health related decisions, condition of health, physical and mental age and condition, physical or mental activities, information on risk-related activities, information on risk-related professional activities, geographic location, travel information, the level of risk associated with the individual from risk-seeking to risk-averse for one or more activities, associations with one or more individuals deemed to be risk-seeking or risk-averse, or other information known to be used in the liability insurance industry for determining a risk score or cost of liability insurance. In one embodiment, the contextual information and/or decision related information can be obtained through data sources such as portable or wearable devices, portable or wearable health monitoring devices, activity monitoring devices, and external data sources such ratings, reviews or information obtained from external websites or social networking websites.

### Financial Instrument Insurance

In one embodiment, the risk assessment, risk score, underwriting, or cost of insurance is for financial instrument insurance such as a loan or a securitized asset such as a mortgage backed security. In this embodiment, contextual information and/or decision related information can include credit score, financial information and decisions, bank account and credit card information, the level of risk associated with the individual from risk-seeking to risk-averse for one or more activities, associations with one or more individuals deemed to be risk-seeking or risk-averse, or other information known to be used in the financial instrument insurance industry for determining a risk score or cost of insurance for a financial instrument. In one embodiment, the contextual information and/or decision related information can be obtained through data sources such as portable or wearable devices, activity monitoring devices, and external data sources such ratings, reviews or information obtained from external websites or social networking websites.

### Law Enforcement Risk Assessment and Regulation

In one embodiment, the decision related information is used for risk assessment or regulation. For example, in one embodiment, a governmental security organization (such as the Department of Homeland Security) assesses the risk or danger associated with an individual by correlating the risk-related decision-making processes and the decisions with the resulting decision outcomes for the individual. A regulatory agency can use the risk-related information to reduce driving, reduce pollution, or improve safety, for example. In this embodiment, contextual information and/or decision related information can include geographic location, travel information, the level of risk associated with the individual from risk-seeking to risk-averse for one or more activities, or other information known to be used for risk assessment for security or regulatory agencies. In one embodiment, the contextual information and/or decision related information can be obtained through data sources such as portable or wearable devices, activity monitoring devices, and external data sources such contextual postings on social networking websites.

In one embodiment, a method of generating a risk score, a cost of insurance, or a risk score and a cost of insurance for at least one individual based at least in part on risk-related decision-making processes and resulting decision outcomes comprises: directly monitoring or inferring the risk-related decision-making processes and directly monitoring or inferring the resulting decision outcomes for decisions made by the at least one individual using data received from a plurality of sensors and a first processor executing a decision-making process algorithm; and generating the risk score, the cost of insurance, or the risk score and the cost of insurance for the at least one individual based at least in part on one or more correlations between the risk-related decision-making processes and the decisions with the resulting decision outcomes using a second processor executing a second algorithm. In one embodiment, the first processor and the second processor are the same processor and/or the second algorithm comprises the decision-making process algorithm. In this embodiment, the method may further comprise comprising building a cognitive map comprising cognitive information stored on a non-transitory computer-readable media, the cognitive information correlated to risk-related decision-making processes and the decisions made by the at least one individual in different risk-related situations. In one embodiment, the method of generating a risk score, a cost of insurance, or a risk score and a cost of insurance for at least one individual based at least in part on risk-related decision-making processes and resulting decision outcomes comprises building a plurality of cognitive maps comprising cognitive information stored on a non-transitory computer-readable media, the cognitive information correlated to risk-related decision-making processes and decisions made by a plurality of individuals in different risk-related situations.

In one embodiment, a method of generating a risk score, a cost of insurance, or a risk score and a cost of insurance for at least one individual based at least in part on risk-related decision-making processes and resulting decision outcomes comprises: generating one or more cognitive maps comprising cognitive information stored on a non-transitory computer-readable media, the cognitive information correlated to risk-related decision-making processes and decisions made by the at least one individual in different risk-related situations; and prospectively determining a probability of outcome for a risk-related situation using the one or more cognitive maps using a processor executing a propensity model algorithm that analyzes the cognitive information. In this embodiment, the propensity model algorithm may prospectively determine a probability of outcome for a risk-related situation by analyzing the one or more cognitive maps and identifying one or more patterns, relationships, degree of influence, or generalizations between one or more of the risk-related decision-making processes and one or more of the decisions.

In one embodiment, a method of generating a risk score, a cost of insurance, or a risk score and a cost of insurance for at least one individual based at least in part on risk-related decision-making processes and resulting decision outcomes comprises: directly monitoring or inferring the risk-related decision-making processes and directly monitoring the resulting decision outcomes for decisions made by the at least one individual during a first period of time using data received from a plurality of sensors and a first processor executing a decision-making process algorithm; and creating an initial underwriting profile for the at least one individual prior to the first period of time.

In one embodiment, a method of generating a risk score, a cost of insurance, or a risk score and a cost of insurance for at least one individual that relate to the risk associated with operation of a vehicle by the at least one individual is based at least in part on risk-related decision-making processes and resulting decision outcomes for decisions made by the at least one individual using data from one or more sensors analyzed by a decision making process algorithm executed on a first processor.

In one embodiment, a method of generating a risk score, a cost of insurance, or a risk score and a cost of insurance for at least one individual that relates to the risk associated with the performance of a first task by the at least one individual is based at least in part on risk-related decision-making processes and resulting decision outcomes for decisions made by the at least one individual and comprises analyzing data from one or more sensors using a decision making process algorithm executed on a first processor, and one or more of the decisions is associated with the performance of a second task different than the first task by the at least one individual. In this embodiment, the first task can include operation of a vehicle and the second task can include a task distracting from the operation of the vehicle.

In one embodiment, a method of generating a risk score, a cost of insurance, or a risk score and a cost of insurance for at least one individual based at least in part on risk-related decision-making processes and resulting decision outcomes comprises directly monitoring or inferring the risk-related decision-making processes and directly monitoring the resulting decision outcomes for decisions made by the at least one individual using data received from a plurality of sensors and a first processor executing a decision-making process algorithm, wherein at least one of the resulting decision outcomes is a negative decision outcome. In another embodiment, at least one of the resulting decision outcomes is a positive decision outcome.

In another embodiment, directly monitoring or inferring the risk-related decision-making processes and directly monitoring the resulting decision outcomes includes acquiring contextual data from one or more sensors or external data sources related to the decisions made by the at least one individual.

In one embodiment, a method of generating a risk score, a cost of insurance, or a risk score and a cost of insurance for at least one individual based at least in part on risk-related decision-making processes and resulting decision outcomes comprises directly monitoring or inferring the risk-related decision-making processes and directly monitoring the resulting decision outcomes for decisions made by the at least one individual using data received from a portable device, wearable device, or telematics device and a first processor executing a decision-making process algorithm.

In one embodiment, a method of generating a risk score, a cost of insurance, or a risk score and a cost of insurance for at least one individual based at least in part on risk-related decision-making processes and resulting decision outcomes comprises: directly monitoring or inferring the risk-related decision-making processes and directly monitoring the resulting decision outcomes for decisions made by the at least one individual using data from a plurality of sensors; and executing a decision-making process algorithm on a first processor that identifies one or more heuristic decision-making processes from the risk-related decision-making processes.

A method of determining a risk score, a cost of insurance, or a risk score and a cost of insurance based at least in part on monitoring, recording, and communicating data associated with risk-related decisions, the method comprising: monitoring or inferring a plurality of data elements associated with risk-related decision-making processes, decisions, and decision outcomes made by at least one individual using a first processor; and correlating one or more of the risk-related decision-making processes and decisions with one or more of the decision outcomes to produce a cost for the insurance using a second processor. In this embodiment, the first processor and the second processor may be the same processor. In this embodiment, the method may further comprise building a cognitive map comprising cognitive information correlated to risk-related decision-making processes and decisions made by the at least one individual in different risk-related situations. In another embodiment, the method may comprise building a plurality of cognitive maps comprising cognitive information represented in one or more data sets, one or more arrays of data, one or more databases, or other collection of data stored on a non-transitory computer-readable media for a plurality of individuals, the cognitive information comprising risk-related decision-making processes and decisions made by the plurality of individuals in different risk-related situations.

In one embodiment, a method of monitoring data representative of risk-related decisions made by at least one individual comprises: extracting from one or more data sources data elements associated with risk-related decision-making processes, decisions, and decision outcomes for decisions made by the at least one individual; correlating one or more of the risk-related decision-making processes and the decisions with one or more of the decision outcomes to produce one or more correlations that can be used to produce a risk score or cost for insuring the at least one individual using a first processor executing a decision-making process algorithm on the one or more data elements. In this embodiment, the method may further comprise building a cognitive map comprising data elements correlated to risk-related decision-making processes and decisions made by the at least one individual in different risk-related situations. In another embodiment, a method of monitoring data representative of risk-related decisions made by at least one individual comprises building a plurality of cognitive maps comprising one or more data sets, one or more arrays of data, one or more databases, or other collection of data stored on a non-transitory computer-readable media representing risk-related decision-making processes and decisions made by a plurality of individuals in different risk-related situations.

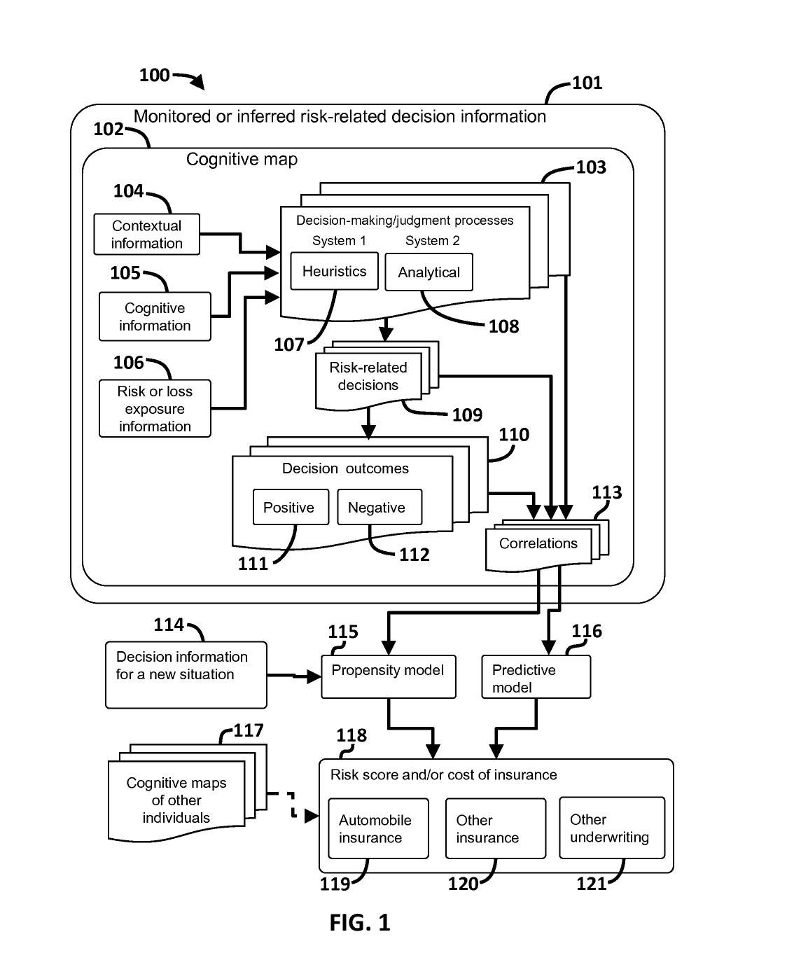

FIG. 1 is an information flow diagram view of one embodiment of a method 100 of determining a risk assessment, risk score, underwriting, or cost of insurance 118 for an individual. In one embodiment, the risk assessment, risk score, underwriting, or cost of insurance 118 for an individual is for automobile insurance 119, other insurance 120, or other underwriting 121. In this embodiment, risk-related decision information 101 is monitored or inferred and can comprise the cognitive map 102 for an individual. The risk-related decision information may include contextual information 104, cognitive information 105, or risk or loss exposure information 106 that is used for one or more risk-related decision-making or judgment processes 103 for one or more risk-related decisions 109 in one or more risk-related situations. The one or more risk-related decision-making or judgment processes 103 can include System 1 decision-making processes 107 (such as reflexive or heuristics) or System 2 decision-making processes 108 (such as analytical or reflective). The contextual information 104, cognitive information 105, and/or risk or loss exposure information 106 along with the decision outcomes 110 of the one or more risk-related decision-making or judgment processes 103 can be used to measure, infer or otherwise determine the use of one or more specific System 1 decision-making processes 107 or System 2 decision-making processes 108 used by the individual in one or more risk-related situations to make one or more risk-related decisions 109. The decision outcomes 110 of the risk-related decisions 109 may be positive decision outcomes 111 or negative decision outcomes 112. One or more correlations 113 between the one or more risk-related decision-making or judgment processes 103 and the decisions 109 with the resulting decision outcomes 110 may be used in a propensity model 115 or a predictive model 116 to generate the risk assessment, risk score, underwriting, or cost of insurance 118. The cognitive map 102 for the individual may include contextual information 104, cognitive information 105, risk or loss exposure information 106, one or more risk-related decision-making or judgment processes 103, one or more risk-related decisions 109, and one or more correlations 113 between the one or more risk-related decision-making or judgment processes 103 and the decisions 109 with the resulting decision outcomes 110 for one or more risk-related situations.

In one embodiment, the propensity model 115 uses one or more risk-related decision-making or judgment processes 103 (such as System 1 decision-making processes 107 or heuristics), the individual's cognitive map 102, one or more correlations 113, and decision information for a new situation 114 to determine a propensity for the individual to be risk-seeking or risk-averse for the new situation. The propensity model 115 may determine the probability of the individual to use one or more risk-related decision-making processes 103 and/or make risk-related decisions 109 that result in negative decision outcomes 112 or positive decision outcomes 111 for a situation. This probability can be used to generate the risk assessment, risk score, underwriting, or cost of insurance 118.

In another embodiment, the predictive model 116 predicts risk outcomes based on a retrospective analysis of the one or more risk-related decision-making or judgment processes 103 used in one or more risk-related situations with the corresponding contextual information 104, cognitive information 105, and/or risk or loss exposure information 106 along with the decision outcomes 110. The predicted risk outcomes or other factors from the predictive model 116 can be used to generate the risk assessment, risk score, underwriting, or cost of insurance 118.

In another embodiment, the method 100 of determining a risk assessment, risk score, underwriting, or cost of insurance 118 for an individual optionally includes using information from one or more cognitive maps of other individuals 117.

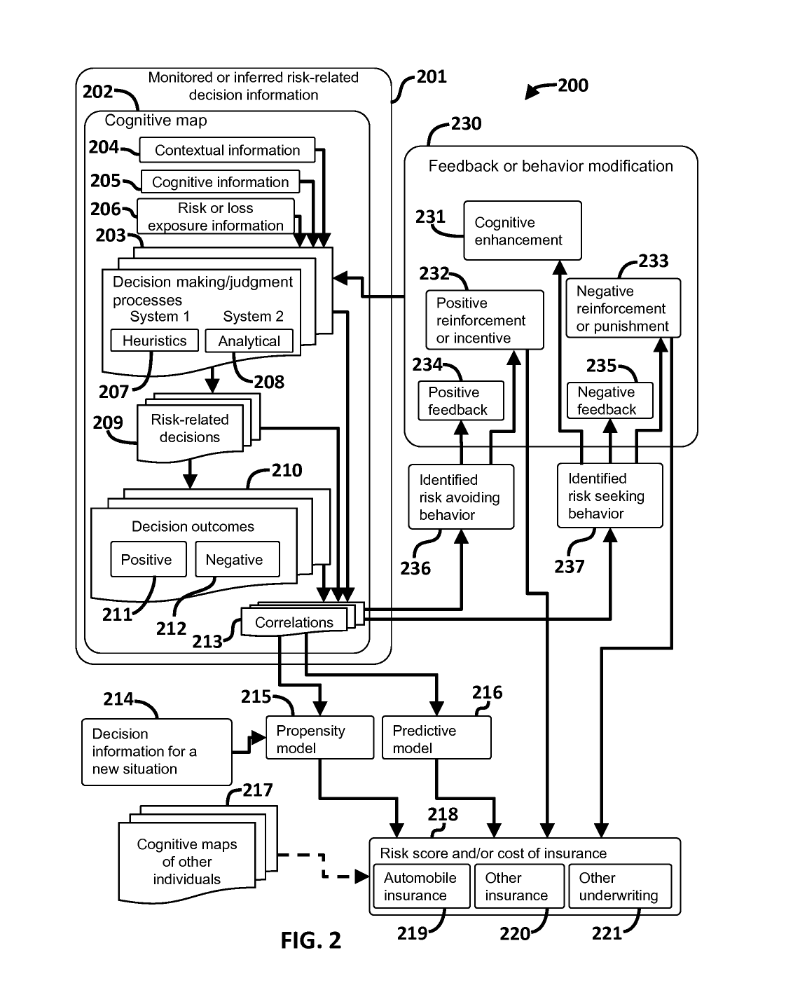

FIG. 2 is an information flow diagram view of one embodiment of a method 200 of determining a risk assessment, risk score, underwriting, or cost of insurance 218 for an individual and providing feedback or behavior modification 230 information, methods, or activities for the individual. In one embodiment, the risk assessment, risk score, underwriting, or cost of insurance 218 for an individual is for automobile insurance 219, other insurance 220, or other underwriting 221. In this embodiment, risk-related decision information 201 is monitored or inferred and can comprise the cognitive map 202 for an individual. The risk-related decision information may include contextual information 204, cognitive information 205, or risk or loss exposure information 206 that is used for one or more risk-related decision-making or judgment processes 203 for one or more risk-related decisions 209. The one or more risk-related decision-making or judgment processes 203 can include System 1 decision-making processes 207 (such as reflexive or heuristics) or System 2 decision-making processes 208 (such as analytical or reflective). The contextual information 204, cognitive information 105, and/or risk or loss exposure information 206 along with the decision outcomes 210 of the one or more risk-related decision-making or judgment processes 203 can be used to measure, infer or otherwise determine the use of one or more specific System 1 decision-making processes 207 or System 2 decision-making processes 208 used by the individual in one or more risk-related situations to make one or more risk-related decisions 209. The decision outcomes 210 of the risk-related decisions 209 may be positive decision outcomes 211 or negative decision outcomes 212. One or more correlations 213 between the one or more risk-related decision-making or judgment processes 203 and the decisions 209 with the resulting decision outcomes 210 may be used in a propensity model 215 or a predictive model 216 to generate the risk assessment, risk score, underwriting, or cost of insurance 218. The cognitive map for the individual may include contextual information 204, cognitive information 205, risk exposure information 206, one or more risk-related decision-making or judgment processes 203, one or more risk-related decisions 209, and one or more correlations 213 between the one or more risk-related decision-making or judgment processes 203 and the decisions 209 with the resulting decision outcomes 210 for one or more risk-related situations.

In one embodiment, the propensity model 215 uses one or more risk-related decision-making or judgment processes 203 (such as System 1 decision-making processes 207 or heuristics), the individual's cognitive map 202, one or more correlations 213, and decision information for a new situation 214 to determine a propensity for the individual to be risk-seeking or risk-averse for the new situation. The propensity model 215 may determine the probability of the individual to use one or more risk-related decision-making processes 203 and/or make risk-related decisions 209 that result in negative decision outcomes 212 or positive decision outcomes 211 for a situation. This probability can be used to generate the risk assessment, risk score, underwriting, or cost of insurance 218.

In another embodiment, the predictive model 216 predicts risk outcomes based on a retrospective analysis of the one or more risk-related decision-making or judgment processes 203 used in one or more risk-related situations with the corresponding contextual information 204, cognitive information 205, and/or risk exposure information 206 along with the decision outcomes 210. The predicted risk outcomes or other factors from the predictive model 216 can be used to generate the risk assessment, risk score, underwriting, or cost of insurance 218.

In another embodiment, the method 200 of determining a risk assessment, risk score, underwriting, or cost of insurance 218 for an individual optionally includes using information from one or more cognitive maps of other individuals 217.

The one or more correlations 213 between the one or more risk-related decision-making or judgment processes 203 and the decisions 209 with the resulting decision outcomes 210 may be used to determine identified risk avoiding behavior 236 and/or to determine identified risk seeking behavior 237. The identified risk avoiding behavior 236 can be used to provide positive feedback 234 and/or generate positive reinforcement or incentive 232 (such as a discount on an insurance rate, for example) that may directly, or indirectly through behavior modification, affect or reduce the risk score and/or cost of insurance 218. For example, a reduction in the rate of automobile insurance (positive reinforcement or incentive 232) for identified risk avoiding behavior 236 can incentivize and modify the behavior of the individual in one or more risk-related situations by influencing one or more risk-related decision-making processes 203 in one or more situations such that the individual makes more (or different) risk-related decisions 209 resulting in more positive decision outcomes 211 or fewer negative decision outcomes 212, thus modifying the behavior of the individual to be more risk avoiding or less risk-seeking.

The identified risk seeking behavior 237 can be used to provide negative feedback 235; generate negative reinforcement or punishment 233 (such as a penalty, loss of discount, or price increase for an insurance rate, for example); and/or provide cognitive enhancement techniques or activities 231 that may directly, or indirectly through behavior modification, affect or reduce the risk score and/or cost of insurance 218. For example, an increase in the rate of automobile insurance (negative reinforcement or punishment 233) for identified risk seeking behavior 237 can motivate and modify the behavior of the individual by influencing the use of one or more risk-related decision-making processes 203 in one or more risk-related situations such that the individual makes more (or different) risk-related decisions 209 resulting in more positive decision outcomes 211 or fewer negative decision outcomes 212, thus modifying the behavior of the individual to be more risk avoiding or less risk-seeking.

In one embodiment, the feedback or behavior modification includes one or more cognitive enhancement 231 techniques or activities that can improve cognitive ability or decision-making capabilities for the individual, thereby influencing the use of one or more risk-related decision-making processes 203 in one or more risk-related situations such that the individual makes more (or different) risk-related decisions 209 resulting in more positive decision outcomes 211 or fewer negative decision outcomes 212.

### EQUIVALENTS

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other aspects, advantages, and modifications are within the scope of the invention. This application is intended to cover any adaptations or variations of the specific embodiments discussed herein. Therefore, it is intended that this disclosure be limited only by the claims and the equivalents thereof.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

What is claimed is:

1. A method of generating a risk score, a cost of insurance, or a risk score and a cost of insurance for at least one individual based at least in part on a use of one or more specific risk-related decision-making processes and resulting decision outcomes, the method comprising:
a. receiving first input data from one or more first sensors of a portable or wearable device;
b. storing the first input data on a first non-transitory computer-readable media;
c. executing a decision-making process algorithm on a first processor, the decision-making process algorithm analyzes at least the first input data from the first non-transitory computer-readable media and statistically deduces or infers the use of one or more specific risk-related decision-making processes by the individual;
d. monitoring the resulting decision outcomes for decisions made by the at least one individual by receiving second input data, the second input data received from one or more second sensors or data sources; and
e. generating the risk score, the cost of insurance, or the risk score and the cost of insurance for the at least one individual based at least in part on one or more correlations between the use of the one or more specific risk-related decision-making processes and the decisions with the resulting decision outcomes.

2. The method of claim 1 further comprising storing data representing the risk-related decision-making processes and the decisions made by the at least one individual in different risk-related situations on a second non-transitory computer-readable media.

3. The method of claim 1 further comprising storing data representing a plurality of risk-related decision-making processes and decisions made by a plurality of individuals in different risk-related situations obtained from a plurality of portable of wearable devices on a second non-transitory computer-readable media.

4. The method of claim 1 further comprising:
a. storing third data representing risk-related decision-making processes and decisions made by the at least one individual in different risk-related situations on a second non-transitory computer-readable device; and
b. executing a propensity model algorithm, the propensity model algorithm generating data representing a prospective determination of a probability of outcome for a risk-related situation.

5. The method of claim 4 wherein the propensity model algorithm identifies one or more patterns, relationships, degree of influence, or generalizations between one or more of the risk-related decision-making processes and one or more of the decisions.

6. The method of claim 1 wherein receiving the first input data occurs during a first period of time of operation of the portable or wearable device by the at least one individual; the method further comprising generating an initial underwriting profile for the at least one individual prior to the first period of time.

7. The method of claim 1 wherein the first input data includes data representing operation of a vehicle by the at least one individual, and the risk score, the cost of insurance, or the risk score and the cost of insurance relate to the risk associated with operation of the vehicle by the at least one individual.

8. The method of claim 1 wherein the risk score, the cost of insurance, or the risk score and the cost of insurance relate to the risk associated with the performance of a first task by the at least one individual; and one or more of the decisions is associated with the performance of a second task different than the first task by the at least one individual.

9. The method of claim 8 wherein the first task includes operation of a vehicle and the second task is a task distracting from the operation of the vehicle.

10. The method of claim 1 wherein at least one of the resulting decision outcomes is a negative decision outcome.

11. The method of claim 1 wherein at least one of the resulting decision outcomes is a positive decision outcome.

12. The method of claim 1 further comprising acquiring contextual data related to the decisions made by the at least one individual.

13. The method of claim 7 wherein the vehicle comprises a telematics device and the decision-making process algorithm further analyzes at least the first input data and data from the telematics device.

14. The method of claim 1 wherein the decision-making algorithm statistically deduces or infers the use of one or more heuristic decision-making processes from the risk-related decision-making processes.

15. A method of determining a risk score, a cost of insurance, or a risk score and a cost of insurance based at least in part on monitoring, recording, and communicating data associated with risk-related decisions, the method comprising:
a. monitoring or inferring a plurality of data elements obtained from one or more sensors of a portable or wearable device comprising a non-transitory computer readable medium, the plurality of data elements associated with risk-related decision-making processes, decisions, and decision outcomes made by at least one individual;
b. recording the plurality of data elements on the non-transitory computer readable medium;
c. communicating the plurality of data elements using a radio transceiver from the portable or wearable device to a device remote from the portable or wearable device; and
d. correlating one or more of the risk-related decision-making processes and decisions with one or more of the decision outcomes to produce a cost for the insurance using a first processor.

16. The method of claim 15 further comprising building a cognitive map comprising the plurality of data elements, the plurality of data elements associated with risk-related decision-making processes and decisions made by the at least one individual in different risk-related situations.

17. The method of claim 15 further comprising building a plurality of cognitive maps comprising a second plurality of data elements associated with risk-related decision-making processes and decisions made by a plurality of individuals in different risk-related situations.

18. A method of monitoring data representative of risk-related decisions made by at least one individual, the method comprising:
a. extracting first input data from one or more sensors on a portable or wearable device, the first input data associated with risk-related decision-making processes, decisions, and decision outcomes for decisions made by the at least one individual;
b. analyzing the first input data using a first processor executing a first algorithm, the first algorithm correlating one or more of the risk-related decision-making processes and the decisions with one or more of the decision outcomes to produce one or more correlations that can be used to produce a risk score or cost for insuring the at least one individual;
c. monitoring second input data from the one or more sensors of the portable or wearable device; and
d. processing the second input data to identify a risk-related situation or decision based on the one or more correlations.

19. The method of claim 18 further comprising building a cognitive map of data comprising at least the first input data and the second input data, the cognitive map of data associated with risk-related decision-making processes and decisions made by the at least one individual in different risk-related situations.

20. The method of claim 18 further comprising building a plurality of cognitive maps comprising a plurality of data sets, the plurality of data sets comprising at least the first input data and the second input data, the plurality of data sets associated with risk-related decision-making processes and decisions made by a plurality of individuals in different risk-related situations.

21. The method of claim 1 wherein the portable or wearable device comprises at least one transceiver, the method further comprising transmitting the first input data, the second input data, the risk score, the cost of insurance, or the risk score and cost of insurance to a processor remote from the portable or wearable device in wireless radio communication with the portable or wearable device using the at least one transceiver.

22. The method of claim 1 further comprising the portable or wearable device providing feedback information to the individual based at least in part on the one or more correlations, the feedback provided by the portable or wearable device is in the form of a visual notification, auditory notification, sensory notification, or an indirect notification.

23. The method of claim 22 wherein the portable or wearable device comprises a display, the feedback information is in the form of a visual notification, the visual notification including the portable device changing the display to indicate a risk related situation or a risk related behavior based on the one or more correlations.
